(19) United States
(12) Patent Application Publication
(10) Pub. No.: US 2026/0213469 A1
(43) Pub. Date: Jul. 23, 2026

(54) ELECTRICAL CONNECTOR AND ASSEMBLING METHOD THEREOF

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: JIA-HAU LIU, New Taipei (TW); HUNG-CHENG LIAO, New Taipei (TW)

(21) Appl. No.: 19/454,870

(22) Filed: Jan. 21, 2026

(30) Foreign Application Priority Data
Jan. 21, 2025 (CN) 202510096565.2

(51) Int. Cl. H01R 13/6596; H01R 4/02; H01R 13/50; H01R 13/6471; H01R 13/6597; H01R 43/20

(52) U.S. Cl. CPC H01R 13/6596; H01R 4/029; H01R 13/50; H01R 13/6597; H01R 43/20; H01R 13/6471

(57) ABSTRACT

An electrical connector includes: an insulator having a base portion extending longitudinally along a first direction and a tongue plate extending forward along a second direction from the base portion; two rows of terminals including a row of first terminals located at a lower face of the tongue plate and a row of second terminals located at an upper face of the tongue plate; and a grounding member being located in the insulator and including a front horizontal pole, a rear horizontal pole, and multiple shielding portions therebetween; wherein some of the shielding portions are provided with respective avoiding notches penetrating along an upper and lower direction perpendicular to the first direction and the second direction and extending across the front horizontal pole along the second direction, and the insulator has plural supporting ribs protruding into the respective avoiding notches.

### BACKGROUND OF THE INVENTION

### Field of the Invention

The present invention relates to an electrical connector.

### Description of Related Arts

U.S. Pat. No. 11,211,750 discloses a plug connector which includes an insulative plug housing, a plurality of plug contacts, and a plug grounding bar. The plug housing includes a base and a tongue forwardly extending from the base. The plug housing has a receiving groove extending from the base to the tongue and opens backward for receiving the grounding bar. Since the grounding bar includes a pair of poles extending continuously in a longitudinal direction, the receiving groove must be completely emptied to accommodate the grounding bar, and this, in turn, leads to a bad strength of the tongue.

Therefore, it is desired to provide an electrical connector with improved strength.

### SUMMARY OF THE INVENTION

An object of the present invention is to provide an electrical connector with improved strength.

To achieve the above object, an electrical connector includes: an insulator having a base portion extending longitudinally along a first direction and a tongue plate extending forward along a second direction from the base portion; two rows of terminals including a row of first terminals located at a lower face of the tongue plate and a row of second terminals located at an upper face of the tongue plate; and a grounding member being located in the insulator and including a front horizontal pole, a rear horizontal pole, and multiple shielding portions therebetween; wherein at least some of the shielding portions are provided with respective avoiding notches penetrating along an upper and lower direction perpendicular to the first direction and the second direction and extending across the front horizontal pole along the second direction, and the insulator has plural supporting ribs protruding into the respective avoiding notches.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector of this invention;

FIG. 2 is another perspective view of the electrical connector in FIG. 1;

FIG. 3 is another perspective view of the electrical connector in FIG. 1;

FIG. 4 is an exploded perspective view of the electrical connector in FIG. 1;

FIG. 5 is another exploded perspective view of the electrical connector in FIG. 4;

FIG. 6 is another exploded perspective view of the electrical connector in FIG. 4;

FIG. 7 is a perspective view of the connecting portions, a grounding member and a terminal module;

FIG. 8 is another perspective view of the connecting portions, the grounding member and the terminal module;

FIG. 9 is an exploded perspective view of the electrical connector, wherein the terminal module together with the grounding member is separated from an insulator;

FIG. 10 is another perspective view of the connecting portions, the grounding member and the terminal module in FIG. 7, wherein the grounding member is fixed to the terminal module;

FIG. 11 is a perspective view of the connecting portions, the grounding member and the terminal module that are fixed together; and

FIG. 12 is a cross-sectional view of the electrical connector taken along line A-A of FIG. 1.

### DETAILED DESCRIPTION OF THE PREFERRED EMBODIMENT

Reference will now be made in detail to the preferred embodiments of the present invention.

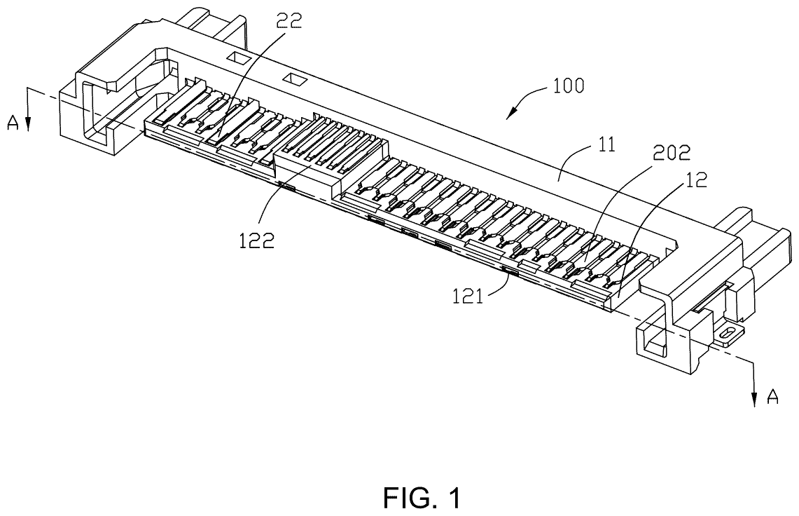

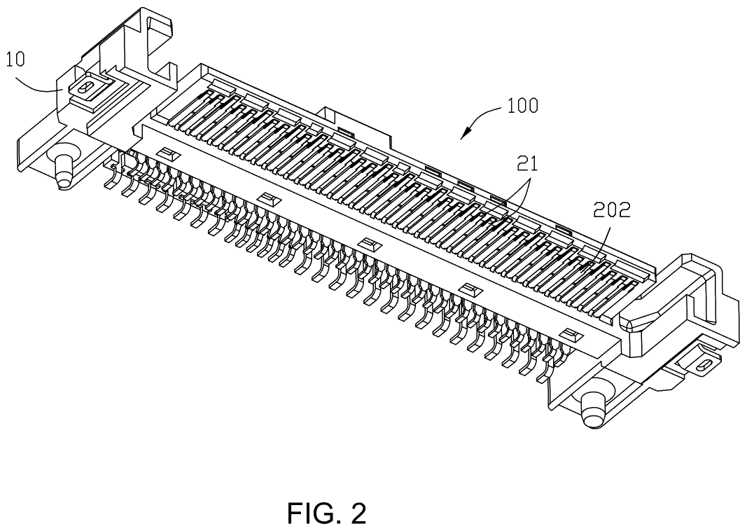

Referring to FIGS. 1-2, an electrical connector 100 of the present invention is a plug connector. The plug connector 100 can mate with a socket connector (not shown) to form an electrical connector assembly for transmitting high-frequency signals. In the embodiment, the plug connector 100 and the socket connector are equipped with a SFF-8639 transmission interface and adopt the latest generation PCIe 5.0 transmission protocol, in addition, the electrical connector assembly is able to support over 32G signal transmission rates, and a transmission bandwidth thereof even reach 128G.

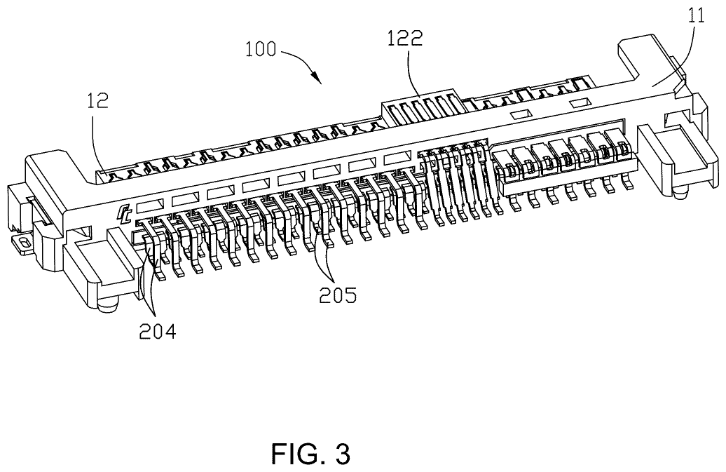

The electrical connector 100 includes an insulator 10 and two rows of terminals 20. The insulator 10 comprises a base portion 11 extending longitudinally along a first direction and a tongue plate 12 extending forward along a second direction from the base portion 11. The terminals 20 include a row of first terminals 21 arranged on a lower face of the tongue plate 12 and a row of second terminals 22 arranged on an upper face of the tongue plate 12. Combined with FIG. 3, the upper face of the tongue plate 12 is provided with a protruding key 122, and the second terminals 22 are located on the protruding key 122 and two sides of the protruding key 122 along the second direction. Each terminal 20 comprises a fixing portion (not labeled) embedded in the base portion 11, a contacting portion 202 extending forward from the fixing portion and exposed on the corresponding face of the tongue plate 12, and a tail portion extending rearward and downward from the fixing portion. The tail portion includes a downward portion 204 extending from the fixing portion and a horizontal portion 205 extending from the downward portion 204.

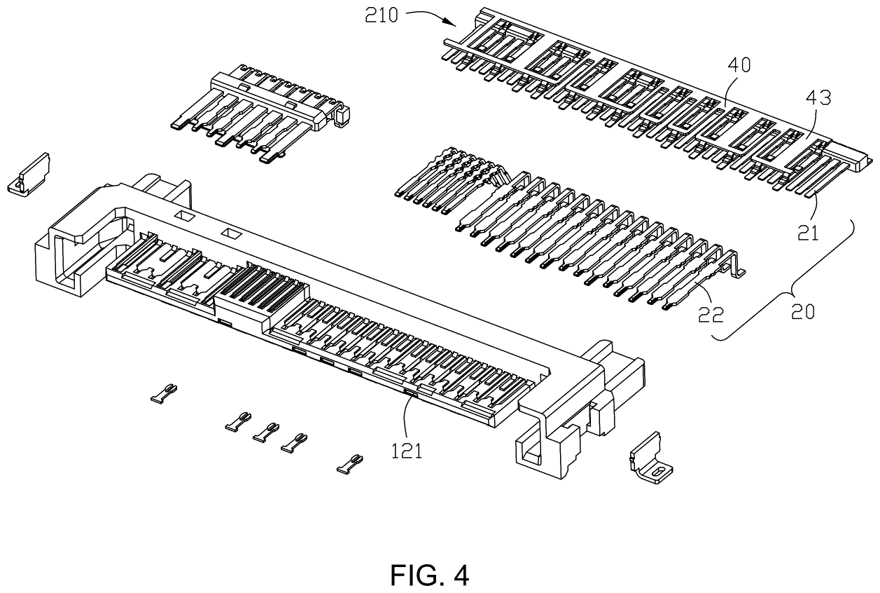

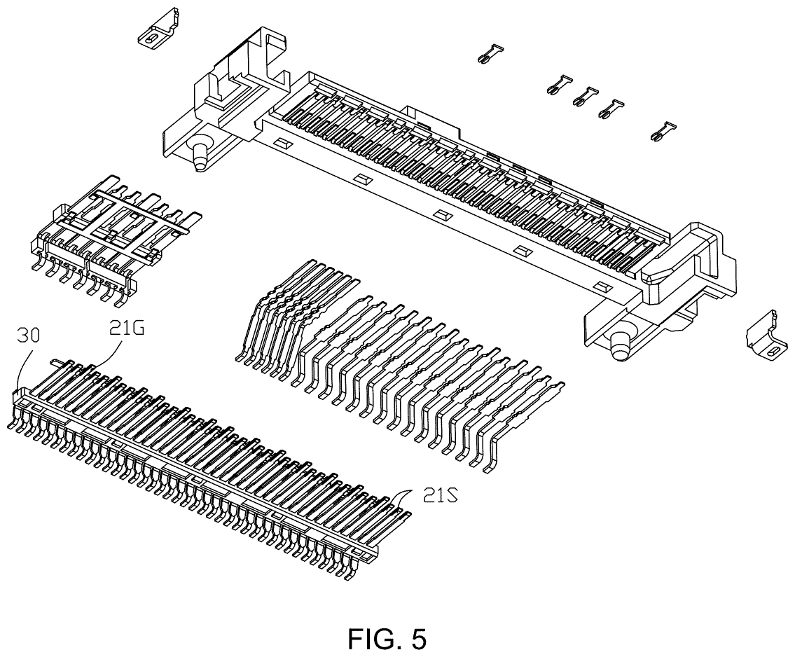

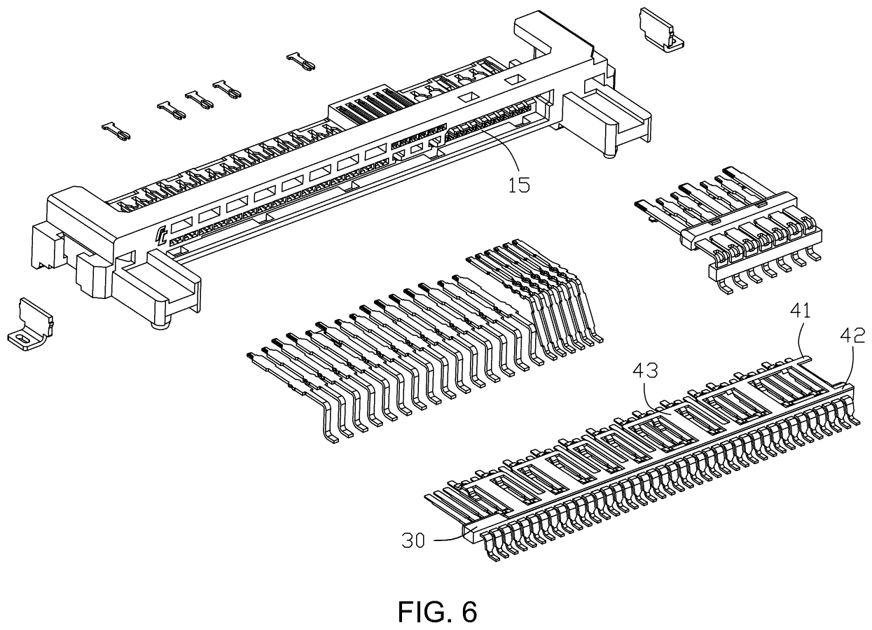

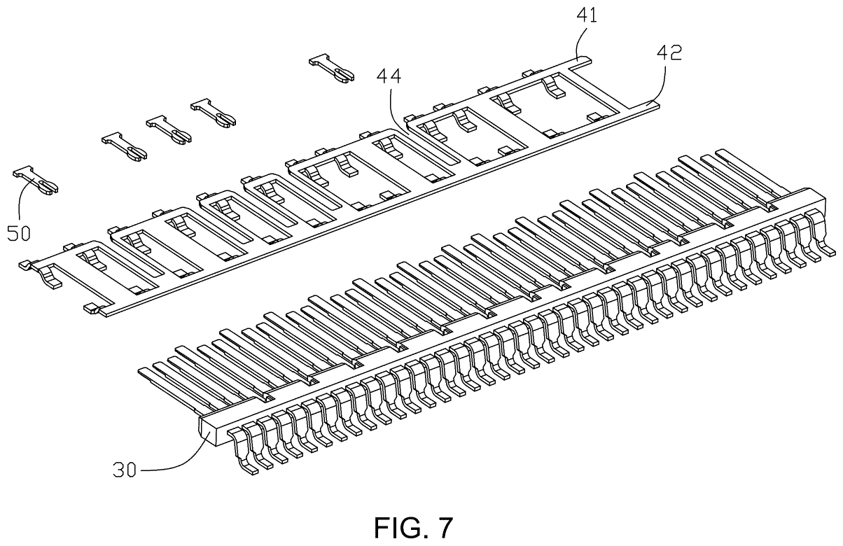

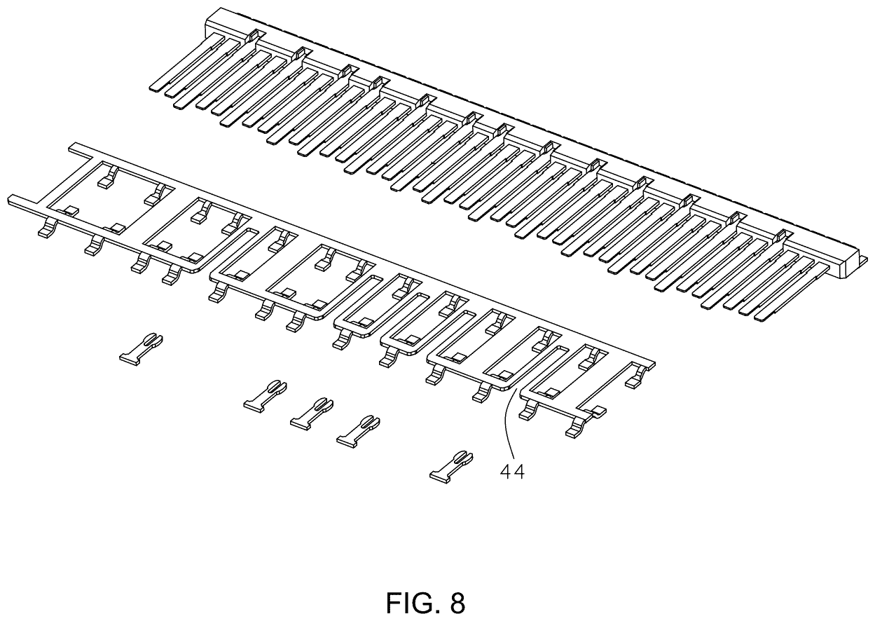

Combined with FIGS. 4-8, the row of the first terminals 21 are fixed by an insulating strip 30 to form a terminal module 210. The insulator 10 includes a receiving groove 15 for accommodating the terminal module The first terminals 21 include plural signal terminal pairs 21S and grounding terminals 21G located at two sides of the corresponding signal terminal pairs 21S in the first direction. The electrical connector 100 also includes a grounding member 40 located within the tongue plate 12 and on a side of the terminal module 210 near the second terminals 22. The grounding member 40 includes a front horizontal pole 41 and a rear horizontal pole 42 parallel to the front horizontal pole 41, and plural shielding portions 43 therebetween. The shielding portions 43 shield over the signal terminal pairs 21S, and are provided with avoiding notches 44. The avoiding notches 44 penetrate the shielding portions 43 in an upper and lower direction and go across the front horizontal pole 41 along the second direction. Preferably, the rear horizontal pole 42 is supported directly on the insulating strip 30, allowing the grounding member 40 to be stably fixed to the terminal module 210.

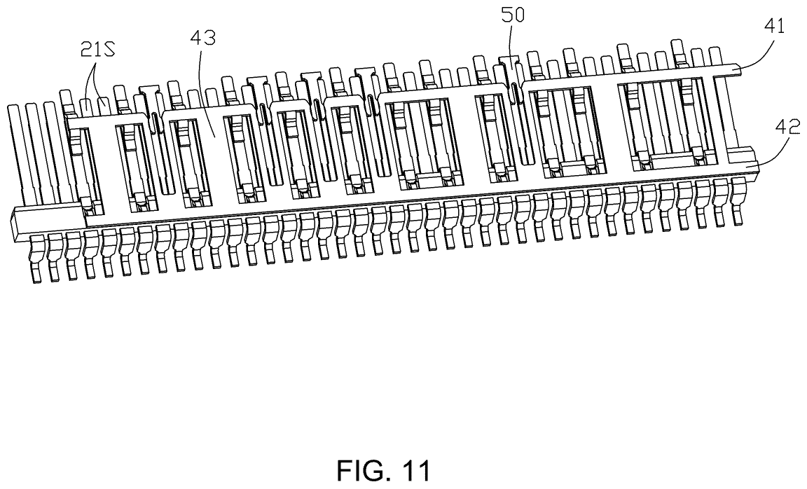

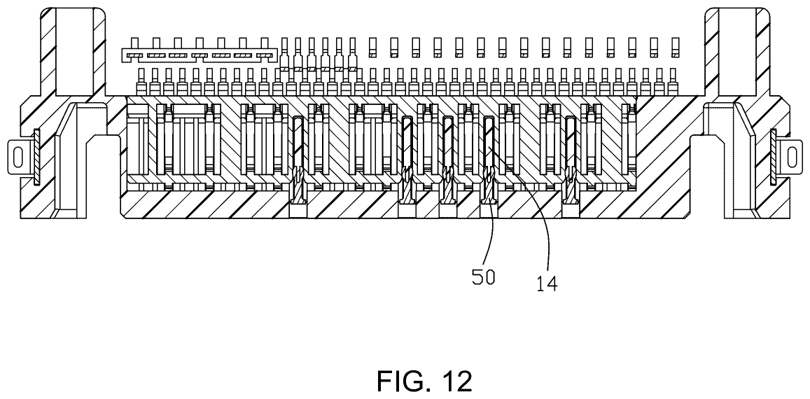

Combined with FIGS. 11-12, the insulator 10 is provided with plural supporting ribs 14 protruding into the avoiding notches 44 along the upper and lower direction to strength the tongue plate 12. That is, receiving groove 15 is not completely hollowed out, instead, some supporting ribs 14 are provided within receiving groove 15. Preferably, the avoiding notch 44 is configured as a U-shape and opens forward. Since the supporting ribs 14 can go into the avoiding notches 44 through the opening of the avoiding notches 44 when the grounding member 40 is inserted into the receiving groove 15, the supporting ribs 14 are able to strength the tongue plate but without a hindrance to the installation of the grounding member 40.

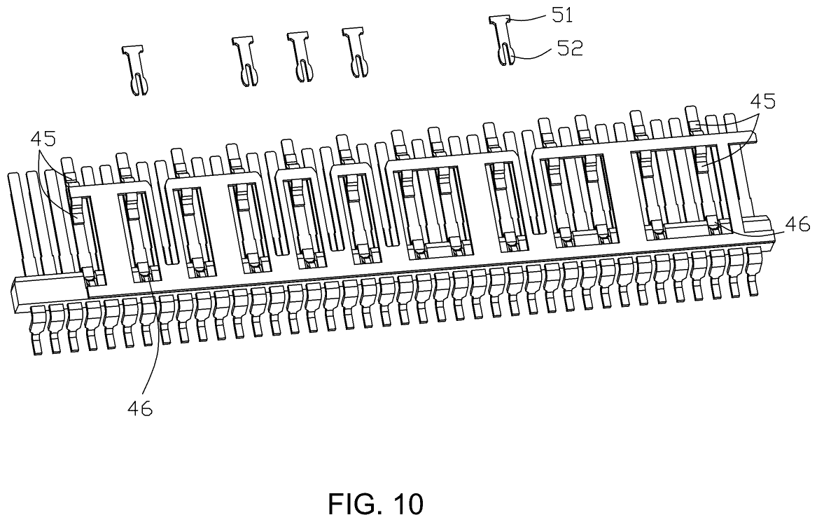

Referring to FIGS. 4-8 and 10-11, electrical connector 100 further includes plural connecting members 50 inserted into the avoiding notches 44. A front end of the tongue plate 12 is provided with plural slots 121 that intercommunicate with the corresponding avoiding notches 44. The connecting members 50 are inserted into a front part of the avoiding notches 44 from the slots 121 in a front-to-rear direction. The connecting members 50 includes a main body 51 and two elastic arms 52 extending from the main body 51. The two elastic arms 52 are electrically connected to the two side walls of the corresponding avoiding notch 44 to electrically connect the front horizontal pole 41 along its length direction. Preferably, the two elastic arms 52 are outwardly convex in an arc shape. The arc-shaped elastic arms 52 not only serve as a guide when the connecting member 50 is inserted into the avoiding notches 44 but also ensure that the two elastic arms 52 are well electrically connected to the two side walls of the avoiding notches 44. The grounding member 40 includes plural groups of grounding portions, each group of grounding portions includes two first grounding portions 45 and a second grounding portions 46 and is connected to a same corresponding grounding terminal 21G. The first grounding portions 45 extend from the two side edges of the front horizontal pole 41, in other words, one of the first grounding portion 45 extends forward from a front edge of the front horizontal pole 41, and the other first grounding portion 45 extends backward from a rear edge of the front horizontal pole. The second grounding portion 46 extends forward from the front edge of the rear horizontal pole 42.

In the embodiment, the receiving groove 15 extends from the base portion to the tongue plate 12 and opens rearward at the base portion. The grounding member 40 together with the terminal module 210 is inserted into the receiving groove 15 as a whole. Preferably, the grounding member 40 is fixed to the terminal module by soldering the first and second grounding portions 45, 46 to the corresponding grounding terminals 21G of the row of first terminals 21. The specific installation method is as follows: step 1, providing an insulator 10 with the receiving groove 15 and having plural supporting ribs 14 protruding into the receiving groove 15; step 2, providing the terminal module 210 with the insulating strip 30 and the row of first terminals 21 retained in the insulating strip 30; step 3, providing a grounding member 40 having a front horizontal pole 41, a rear horizontal pole 42, and multiple shielding portions 43 therebetween, and fixing the grounding member 40 to one side of the terminal module 210. Preferably, the shielding portions 43 are provided with avoiding notches 44 penetrating the shielding portions 43 in a vertical direction/the upper and lower direction and going across the front horizontal pole 41 along the second direction; step 4, inserting the terminal module 210 together with the grounding member 40 into the receiving groove 15 from a rear to front direction to ensure that the supporting rib 14 is accommodated within the avoiding notch 44. After step 4, inserting the connecting member 50 into the avoiding notch 44 through the slot 121 from the front to rear direction, and thus, the connecting members 50 are electrically connected to the two side walls of the avoiding notch 44.

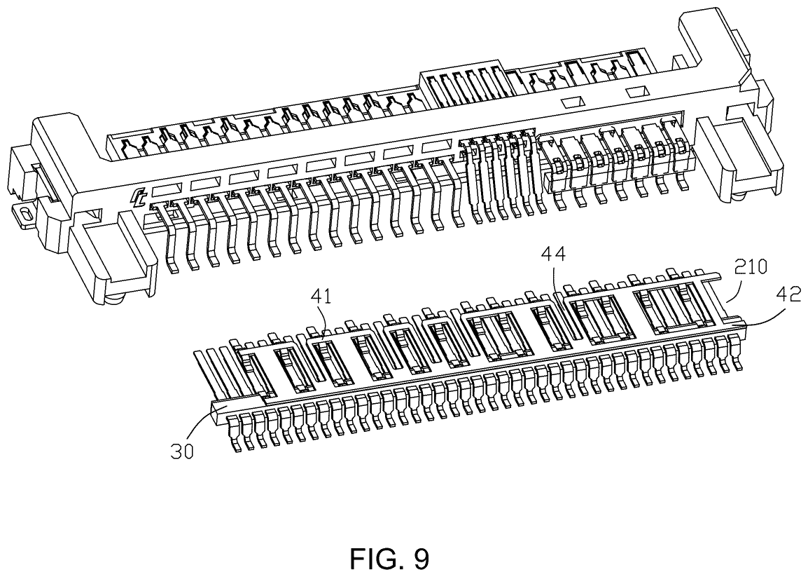

Referring to FIGS. 3 and 9, in the embodiment, since the downward extension portions 204 and the horizontal portions 205 of the second terminals 22 are behind the downward extension portions 204 and horizontal portions 205 of the first terminals 21 correspondingly, an installation of the terminal module 210 to the insulator will be hindered if an installation of the second terminals 22 to the insulator 10 is before the installation of the terminal module 210, so the assembling of the second terminals 22 should be after the step 4.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector comprising:
an insulator having a base portion extending longitudinally along a first direction and a tongue plate extending forward along a second direction from the base portion;
two rows of terminals comprising a row of first terminals located at a lower face of the tongue plate and a row of second terminals located at an upper face of the tongue plate; and
a grounding member being located in the insulator and comprising a front horizontal pole, a rear horizontal pole, and multiple shielding portions therebetween;
wherein at least some of the shielding portions are provided with respective avoiding notches penetrating along an upper and lower direction perpendicular to the first direction and the second direction and extending across the front horizontal pole along the second direction, and the insulator has plural supporting ribs protruding into the respective avoiding notches.

2. The electrical connector as claimed in claim 1, further comprising plural connecting portions, and wherein the avoiding notch is U-shaped and opens forward, and the plural connecting portions are located in the avoiding notches and near the front horizontal pole to electrically connect the front horizontal pole.

3. The electrical connector as claimed in claim 2, wherein the connecting portion comprises a main body and two elastic arms extending from the main body, and the two elastic arms contacts two inner side walls of the corresponding avoiding notch respectively.

4. The electrical connector as claimed in claim 2, wherein the tongue plate has plural slots intercommunicating with the avoiding notches, and the connecting portions are inserted into the avoiding notches through the slots.

5. The electrical connector as claimed in claim 1, wherein the row of the first terminals comprises plural signal terminal pairs of and plural grounding terminals, and the shielding portions shield over the corresponding signal terminal pairs.

6. The electrical connector as claimed in claim 5, wherein the insulator comprises a receiving groove extending from the base portion to the tongue plate and opening backward at the base portion, the row of the first terminals fixed by an insulating strip together with the grounding member are inserted into the receiving groove from an opening at the base portion.

7. The electrical connector as claimed in claim 5, wherein the grounding member comprises plural groups of grounding portions, and each group of grounding portions is connected to a same grounding terminal and comprises two first grounding portions extending from the two sides of the front horizontal pole and a second grounding portion extending from a front side of the rear horizontal pole.

8. The electrical connector as claimed in claim 7, wherein the row of the first terminals are fixed by an insulating strip, and the grounding member are fixed to the row of the first terminals by welding the grounding portions to the corresponding grounding terminals.

9. An electrical connector comprising:
an insulator having a base portion extending longitudinally along a first direction and a tongue plate extending forward along a second direction from the base portion;
a row of first terminals being located at one face of the tongue plate and comprising plural signal terminal pairs and plural grounding terminals located at two sides of the signal terminal pairs in the first direction; and
a grounding member located in the insulator and at one side of the row of first terminals in an upper and lower direction, the grounding member comprising a front horizontal pole, a rear horizontal pole, and multiple shielding portions therebetween;
wherein the shielding portions shield at one side of the corresponding signal terminal pairs, at least some of the shielding portions are provided with respective avoiding notches, the avoiding notches go across the front horizontal pole along the second direction and open forward, and the insulator has plural supporting ribs protruding into corresponding avoiding notches.

10. The electrical connector as claimed in claim 9, wherein all of the shielding portions are provided with avoiding notches.

11. The electrical connector as claimed in claim 9, wherein the tongue plate has plural slots at a front end thereof and intercommunicating with the avoiding notches, and plural connecting portions are inserted into the avoiding notches through the corresponding slots to electrically connect the front horizontal pole along the first direction.

12. An assembling method of an electrical connector, comprising the steps of:
providing an insulator with a receiving groove and plural supporting ribs protruding into the receiving groove;
providing a terminal module having an insulating strip and a row of first terminals fixed in the insulating strip;
providing a grounding member comprising a front horizontal pole, a rear horizontal pole, and multiple shielding portions therebetween, and fixing the grounding member to one side of the terminal module, at least some of the shielding portions having avoiding notches opening forward and going across the front horizontal pole; and
assembling the terminal module together with the grounding member into the receiving groove along a rear to front direction, and making the supporting ribs received in corresponding avoiding notches.

13. The assembling method as claimed in claim 12, wherein a front end of the insulator has plural slots intercommunicating with the corresponding avoiding notches, and further comprising a step of inserting plural connecting portions into the avoiding notches from the slots after the step of assembling.

14. The assembling method as claimed in claim 12, wherein the insulator comprises a base portion and a tongue plate extending forward from the base portion, the receiving groove opens rearward at the base portion and extends to the tongue plate.
